(19) United States
(12) Patent Application Publication
(10) Pub. No.: US 2018/0200718 A1
(43) Pub. Date: Jul. 19, 2018

(54) REACTION CELL FOR ASYNCHRONIOUSMULTIPEPTIDE INSTRUMENT

(71) Applicant: Vasiliy Abramov, Louisville, KY (US)

(72) Inventor: Vasiliy Abramov, Louisville, KY (US)

(21) Appl. No.: 15/409,048

(22) Filed: Jan. 18, 2017

(51) Int. Cl. B01L 3/00

(52) U.S. Cl. CPC B01L 3/523; B01L 2400/0605; B01L 2200/0621; B01L 2200/026

(57) ABSTRACT

A reaction cell for an automated peptide synthesizer consists of a body having adjacent first and second reaction wells for simultaneous reactions. The first reaction well is in fluid communication with the second reaction well for reagent pre-activation simultaneously with an amino acid addition for solid state peptide production.

### FIELD OF THE INVENTION

This invention relates to the synthesis of peptides and more particularly to automated peptide synthesis instruments.

### BACKGROUND OF THE INVENTION

In the synthesis of peptides by solid state peptide synthesis (SPPS) automated peptide synthesis instruments provide substantial labor and time savings in the solid state synthesis of peptides. There are a variety of peptide instruments in the prior art, however, of particular interest is the TETRIS™ asynchronous multipeptide instrument distributed by Advanced Chemtech. Louisville, K.Y. This instrument comprises a carousel carrying a plurality of individual reaction cells for moving the cells between injection stations containing reagents and ancillary solvents for delivery to the reaction cells. The instrument further includes purge stations for removing liquids from the reaction cells upon completion of a synthesis step. The instrument is programmable to produce a variety of peptides.

### SUMMARY OF THE INVENTION

At each step of a peptide synthesis there can be an activation step to prepare the particular reagents for the next reaction. The present invention is designed for use in automated chemical synthesizers. As pointed out above for purposes of description the invention will be described in connection with the TETRIS™ peptide synthesizer. With conventional reaction cells for the TETRIS™ the cell is moved into alignment with an injection station containing the activation reagent following the cell is moved to the injection station to receive the next amino acid to be coupled according to the selected protocol. In other synthesizers the reagents may be brought to the reaction cell rather than moving the reaction cell to stationary injection stations.

The efficiency of the instrument is improved and time saved the present invention comprising by the an improved reaction cell adapted for the TETRIS™ instrument in which the activation step and the reaction step can be carried out simultaneously in the same reaction cell. In accordance with the invention a novel reaction cell is provided that comprises duel but separate wells that are in one way fluid communication. In this manner a reaction step can be carried out simultaneously with an activation step so as to essentially combine two steps of a synthesis in a single cell. Both the activation step and the reaction step require some time in which to complete the steps. By carrying out both steps at essentially the same time the efficiency of the instrument is improved.

### BRIEF DESCRIPTION OF THE DRAWINGS

FIG. 1 is a perspective view of a preferred embodiment of the reaction cell of the invention;

FIG. 2 is a perspective view of FIG. 1 showing the interior of FIG. 1;

FIG. 3 is a top plan view of the reaction cell of FIG. 1;

FIG. 4 is a bottom plan view of the reaction cell of FIG. 1;

FIG. 5 is an end sectional view of the reaction cell of FIG. 1 taken through line A-A of FIG. 3;

FIG. 6 is a side sectional view taken through line E-E of FIG. 2.

### DESCRIPTION OF THE INVENTION

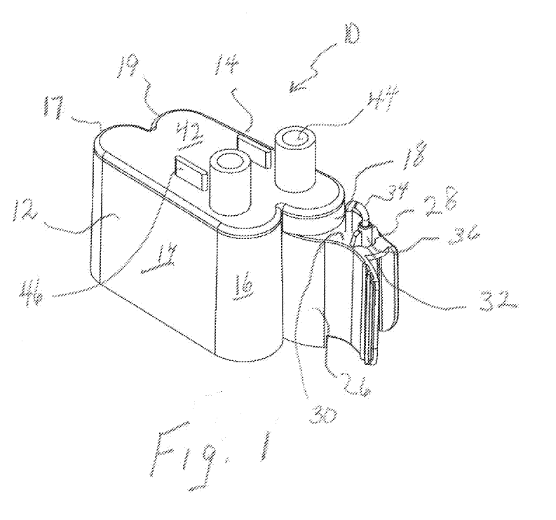

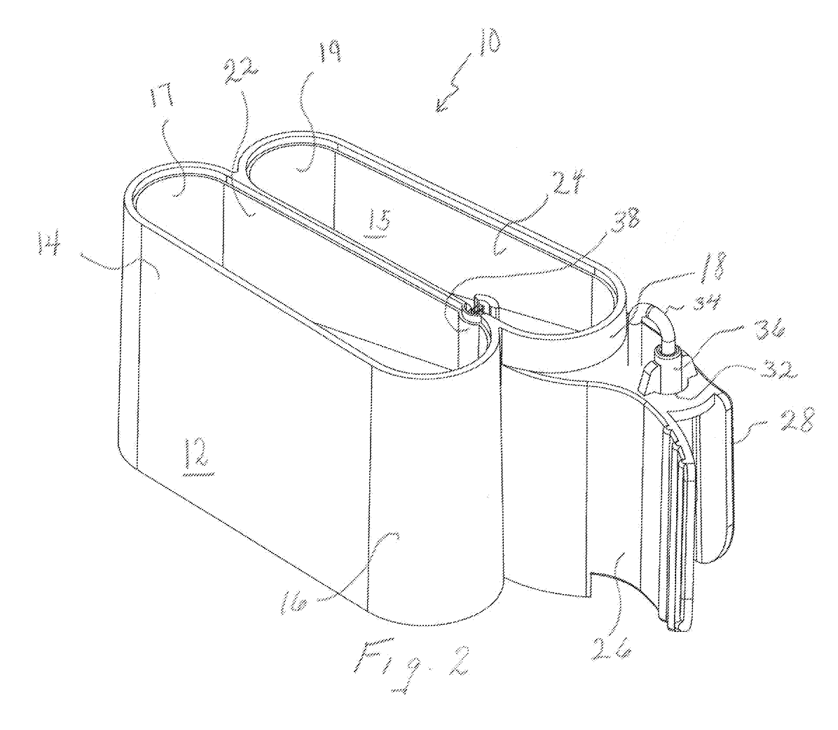

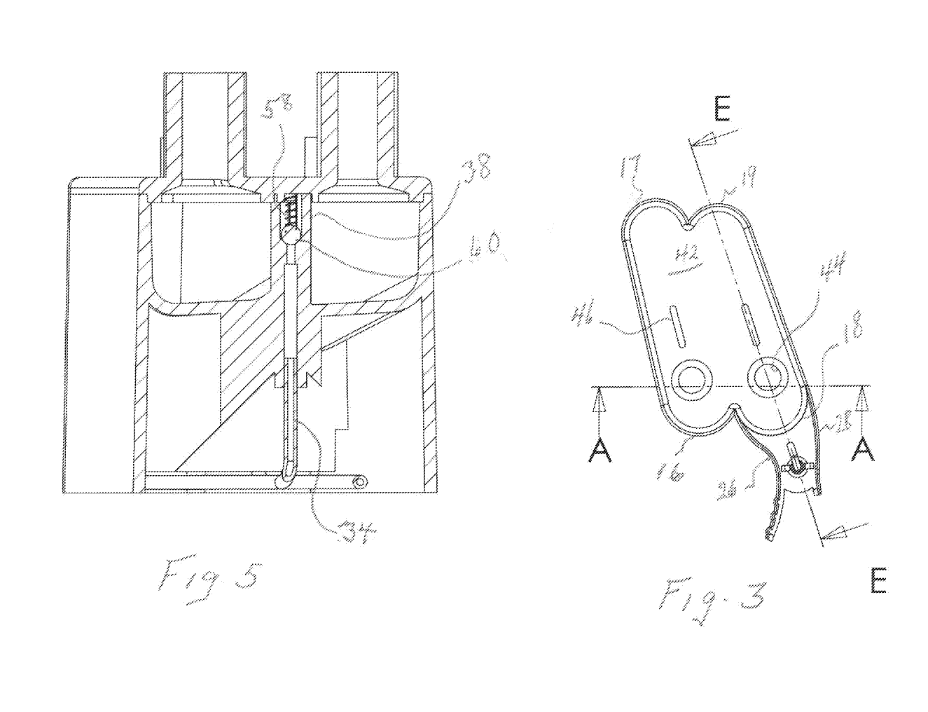

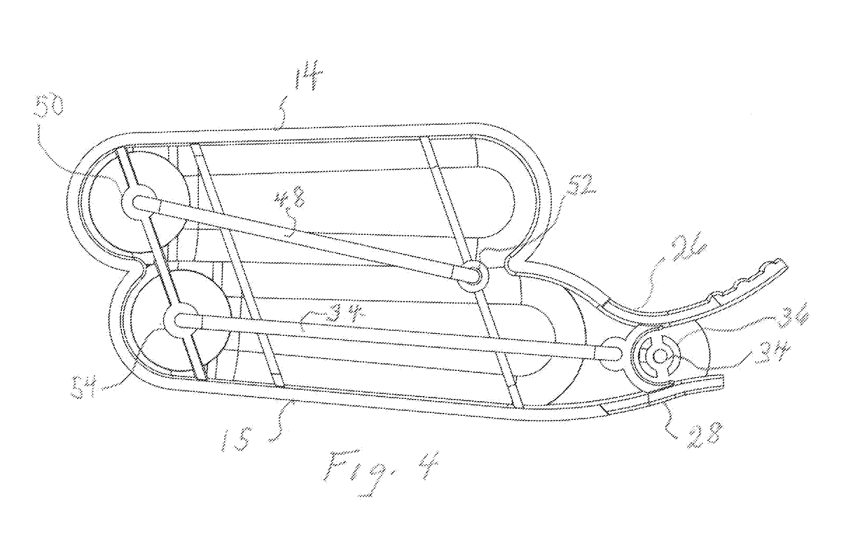

FIG. 1 and FIG. 2 illustrate a reaction cell shown generally as 10 comprising a body 12 having opposed sidewalls 14 and 15, end walls 16, 17, 18, and 19 and inner common wall 20 which define a pre-activation well 22 and a reaction well 24 containing a solid support for solid state peptide synthesis (FIG. 4). The inner common well 22 and side wall 15 are provided with extensions 26 and 28 and a transverse member 30 extends from the end wall 18 and between the extensions 26 and 28. Ports 32 are provided for a discharge line 34 and a discharge line connector body 36 for discharge of spent reagent from the well 24. The inner common wall 20 defines a valve body 38 for a one way spring loaded valve (FIG. 4). The wells 22 and 24 are closed by a lid 42 having ports 44 for introduction of reagents to the wells. Well 22 is the pre-activation well and the well 24 contains the solid support for a solid state peptide reaction. Vertically extending members 46 on the lid 42 serve as grips for handling the lid.

Referring to FIG. 4 transfer line 48 provides fluid communication between port 50 and port 52 for transfer of pre-activated reagents from well 22 to well 24 for the peptide synthesis. Discharge line 34 extends between port 54 and the discharge line connector 36 for discharge of spent reagents.

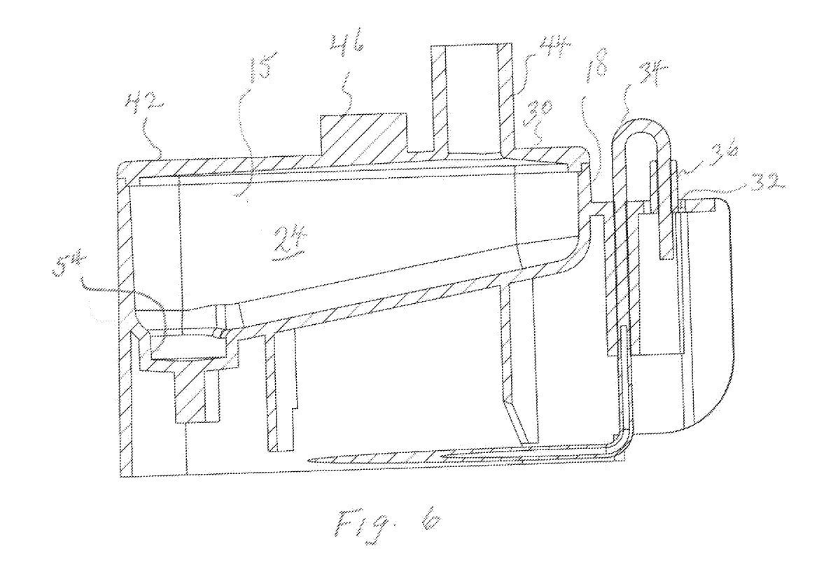

Referring to FIG. 5 more clearly illustrates the discharge line 34 leading to a one way valve 56 comprising a check valve body 60 seated in the valve body 38. The check valve body 60 is loaded by a spring 58 for one way fluid communication between the well 22 and the well 24.

FIG. 6 most clearly shows the discharge line 34 and the discharge line connector 36 for discharging spent reagent through the port 32 to waste.

From the foregoing it can be seen that efficiency of peptide synthesizer instrument is improved by the reaction cell of the present invention in which a pre-activation step can be carried out concurrently with the peptide synthesis.

Having defined the invention I claim:

1. A reaction cell for an automated peptide synthesizer comprising a body defining a first reaction well and an adjacent second reaction well, said first reaction well being in fluid communication with said second well for one way transfer of fluid from said first reaction well to said second reaction well, whereby a first chemical reaction can be carried out in said first reaction well simultaneously with a second chemical reaction in said second reaction well.

2. The reaction cell of claim 1 wherein a transfer line including a check valve in said first reaction well is in fluid communication with said second reaction cell, said check valve preventing fluid communication from said second reaction cell to said first reaction cell.

3. The reaction cell of claim 1 wherein said first reaction well is a pre-activation well and said second reaction well is a peptide synthesis well.
